(19) United States
(12) Patent Application Publication
(10) Pub. No.: US 2006/0099404 A1
(43) Pub. Date: May 11, 2006

(54) Oxidation-resistant rare earth based magnet magnet powder and method for production thereof, compound for rare earth based bonded magnet, rare earth based bonded magnet and method for production thereof

(76) Inventors: Kohshi Yoshimura, Osaka (JP); Kazuhide Oshima, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/541,454

(22) PCT Filed: Jan. 9, 2004
(86) PCT No.: PCT/JP04/00116

§ 371 Date: Jul. 6, 2005

(30) Foreign Application Priority Data
Jan. 10, 2003 (JP) 2003-4694
Feb. 28, 2003 (JP) 2003-54561
May 2, 2003 (JP) 2003-127078
Jun. 11, 2003 (JP) 2003-166056

(51) Int. Cl. B32B 5/16

(52) U.S. Cl. 428/323; 428/570

(57) ABSTRACT

The objectives of the present invention are to provide an oxidation-resistant rare earth metal-based magnet powder useful for producing rare earth metal-based bonded magnet which is not only excellent in oxidation resistance but also superior in magnetic characteristics and a method for producing the same, a compound for rare earth metal-based bonded magnet, a rare earth metal-based bonded magnet and a method for producing the same. The oxidation-resistant rare earth metal-based magnet powder of the present invention is characterized in that it has on its surface an adhesion layer containing a pigment as a primary component.

### TECHNICAL FIELD

The present invention relates to an oxidation-resistant rare earth metal based magnet powder useful for producing rare earth metal-based bonded magnet which is not only excellent in oxidation resistance but also superior in magnetic characteristics and to a method for producing the same, to a compound for rare earth metal-based bonded magnet, to a rare earth metal-based bonded magnet and to a method for producing the same.

### BACKGROUND ART

Rare earth metal-based bonded magnets are produced by shaping rare earth metal-based magnet powders, for instance, R—Fe—B (where R represents a rare earth element) based magnet powders represented by an Nd—Fe—B based magnet powder, into a predetermined shape using a thermoplastic resin or a thermosetting resin and the like as a binder. These magnets are inferior in magnetic characteristics as compared with rare earth metal-based sintered magnets because a resin binder is incorporated; however, they still possess sufficiently high magnetic characteristics as compared with ferrite magnets, and have outstanding characteristics unavailable in rare earth metal-based sintered magnets, such as the ready availability of magnets with complicated or thin shapes, or radial anisotropic magnets. Thus, rare earth metal-based bonded magnets are extensively used particularly in compact motors such as spindle motors and stepping motors, and recent demands for the rare earth metal-based bonded magnets are increasing.

Although a rare earth metal-based magnet powder possesses superior magnetic characteristics, it suffers a problem that it is apt to cause corrosion or oxidation due to R or Fe accounting for high ratio in the composition. Accordingly, in producing a rare earth metal-based bonded magnet, a rare earth metal-based magnet powder is mixed with a dissolved or molten (softened) resin binder to prepare a powdery granular starting material comprising the magnet powder whose surface is coated with the resin binder, which is called a “compound”; thus, the final product is obtained by shaping the compound into a predetermined shape by subjecting the compound to injection molding, compression molding, or extrusion molding; in case a thermosetting resin is used as the resin binder, the molding is further heated to harden the resin binder to obtain the product in its final shape. However, even in case a rare earth metal-based bonded magnet is made into a product in this manner, a rare earth metal-based magnet powder exposed on the surface of the magnet brings about rust generation, or progressive oxidation in air even at a temperature of about 100° C., due to corrosion of the magnet powder by the presence of small amount of acid, alkali, or water; and this sometimes leads to, for instance, the deterioration or fluctuation of magnetic characteristics on assembling the magnets as components. Furthermore, epoxy resins and nylon resins that are generally used as the resin binders permeate water and oxygen. Accordingly, in the rare earth metal-based bonded magnets using these resins as the resin binder, it is undeniable that there is possibility of causing corrosion or oxidation attributed to water or oxygen permeated through the resin. Moreover, in view of the fact that the rare earth metal-based magnet powders are apt to be corroded or oxidized, in case injection molding is performed, it is demanded to take the temperature conditions during kneading and shaping into consideration, and, in case compression molding is performed, the curing treatment after molding must be carried out in an inert gas atmosphere or in vacuum.

Furthermore, a bonded magnet produced by compression molding a compound into a predetermined shape contains pores (voids) on the surface or in the inside of the magnet due to the insufficient filling up of the interstices between the particles of the magnet powder with the resin binder. Thus, the problem is that small amount of acid, alkali, or water may intrude into these pores to cause progressive corrosion from the surface of the magnet, and that this results in rust generation. As a means for solving this problem, there may be thought of increasing the amount of resin binder with respect to the magnet powder blended in the compound; however, in case the blend ratio of the resin binder is increased, it leads to the rise of manufacturing problems due to the impaired fluidity of the compound, or to inferior magnetic characteristics ascribed to the lowered density of magnet powders. Accordingly, an upper limit is set (generally about 3 wt %) in the blend ratio of the resin binder with respect to the magnet powder of a compound. Hence, the method above cannot be an effective means of solving the problem.

In order to overcome the problem above, for example, in JP-A-64-11304, JP-A-7-278602, and the like, is proposed a method of imparting oxidation resistance to a rare earth metal-based magnet powder by forming a coating film made of an inorganic phosphoric acid compound (a coating film containing phosphorus as the component) on the surface of the rare earth metal-based magnet powder. However, when a rare earth metal-based magnet powder having a coating film made of an inorganic phosphoric acid compound formed on the surface thereof is shaped into a predetermined shape to produce a rare earth metal-based bonded magnet, there was found a problem that the magnet suffers considerable aging phenomena in magnetic characteristics due to oxidation. This phenomena is presumed to occur ascribed to the insufficient fluidity of the magnet powder, because breaking of magnet powders occurs due to the molding pressure applied during the shaping of the bonded magnet, thus, for example, the broken surface of the particles, which is apt to be oxidized, becomes exposed to air.

Further, as is well known in the art, various methods have been proposed for the treatment of the pores that are present in rare earth metal-based bonded magnets. For instance, in JP-A-2001-11504 is proposed a method of sealing the pores that are already present; this method is effective for the treatment of pores that are present on the surface of the magnet, however, there is a problem that this method is still insufficient for treating the pores that are present in the inside of the magnet. Accordingly, for pores generating on the surface and in the inside of a rare earth metal-based bonded magnet, it seems more appropriate to study a means for solving the problem from the viewpoint of manufacturing the bonded magnet without generating pores, and not from the viewpoint of sealing the pores already present in the magnet. For instance, the method of producing a bonded magnet using granulated powder described in JP-A-5-129119 is based on this viewpoint, and the method reduces the generation of pores by promoting densification of the molding during compression molding; this method comprises forming a coating film of a solid resin on the surface of the magnet powder nucleus, and then adhering on the surface a magnet powder finer than the magnet powder nucleus with a coating film of a liquid resin interposed therebetween. This method is worth paying attention, however, a problem had been found that it requires carrying out a process having many steps.

Accordingly, the objectives of the present invention are to provide an oxidation-resistant rare earth metal-based magnet powder useful for producing rare earth metal-based bonded magnet which is not only excellent in oxidation resistance but also superior in magnetic characteristics and a method for producing the same, a compound for rare earth metal-based bonded magnet, a rare earth metal-based bonded magnet and a method for producing the same.

### DISCLOSURE OF THE INVENTION

The present invention has been accomplished based on the technical background above, and to achieve the above object, according to a first aspect and feature of the present invention, there is provided an oxidation-resistant rare earth metal-based magnet powder, characterized in that it has on its surface an adhesion layer containing a pigment as a primary component.

According to a second aspect and feature of the present invention, in addition to the first feature, the pigment is an inorganic pigment.

According to a third aspect and feature of the present invention, in addition to the second feature, the inorganic pigment is carbon black.

According to a fourth aspect and feature of the present invention, in addition to the first feature, the pigment is an organic pigment.

According to a fifth aspect and feature of the present invention, in addition to the fourth feature, the organic pigment is an indanthrene based pigment or a phthalocyanine based pigment.

According to a sixth aspect and feature of the present invention, in addition to the first feature, the average particle diameter (major axis diameter) of the pigment is in a range of 0.01 μm to 0.5 μm.

According to a seventh aspect and feature of the present invention, in addition to the first feature, the average particle diameter (major axis diameter) of the rare earth metal-based magnet powder is not larger than 200 μm.

According to an eighth aspect and feature of the present invention, in addition to the seventh feature, the rare earth metal-based magnet powder is an HDDR magnet powder.

According to a ninth aspect and feature of the present invention, in addition to the first feature, it has the adhesion layer adhered to the outermost surface, with one or more interposed layers of coating films formed on the surface of the rare earth metal-based magnet powder.

According to a tenth aspect and feature of the present invention, in addition to the ninth feature, the coating film formed on the surface of the rare earth metal-based magnet powder is a coating film made of an inorganic phosphoric acid compound.

According to an eleventh aspect and feature of the present invention, in addition to the ninth feature, the coating film formed on the surface of the rare earth metal-based magnet powder is a coating film made of a metal.

According to a twelfth aspect and feature of the present invention, there is provided a method for producing an oxidation-resistant rare earth metal-based magnet powder having on its surface an adhesion layer containing a pigment as a primary component, characterized in that the method comprises mixing a rare earth metal-based magnet powder with a treating solution containing the pigment, and then drying the rare earth metal-based magnet powder having adhered to the surface thereof the treating solution containing the pigment.

According to a thirteenth aspect and feature of the present invention, in addition to the twelfth feature, the method comprises mixing a rare earth metal-based magnet powder with a treating solution containing the pigment, and then obtaining by filtration the rare earth metal-based magnet powder having adhered to the surface thereof the treating solution containing the pigment.

According to a fourteenth aspect and feature of the present invention, in addition to the twelfth feature, the pigment accounts for 5 wt % to 33 wt % of the treating solution containing the pigment.

According to a fifteenth aspect and feature of the present invention, in addition to the twelfth feature, the treating solution containing the pigment comprises an organic dispersing medium.

According to a sixteenth aspect and feature of the present invention, there is provided a method for producing an oxidation-resistant rare earth metal-based magnet powder having an adhesion layer containing a pigment as a primary component adhered to the outermost surface with one or more interposed layers of coating films formed on the surface of the rare earth metal-based magnet powder, characterized in that the method comprises mixing a rare earth metal-based magnet powder having one or more layers of coating films formed on the surface thereof with a treating solution containing the pigment, and then drying the rare earth metal-based magnet powder having adhered to the outermost surface thereof the treating solution containing the pigment.

According to a seventeenth aspect and feature of the present invention, there is provided a compound for rare earth metal-based bonded magnet, characterized in that it comprises an oxidation-resistant rare earth metal-based magnet powder according to the first feature and a resin binder.

According to an eighteenth aspect and feature of the present invention, there is provided a rare earth metal-based bonded magnet, characterized in that a compound for rare earth metal-based bonded magnet according to the seventeenth feature is used and shaped into a predetermined shape.

According to a nineteenth aspect and feature of the present invention, there is provided a method for producing a rare earth metal-based bonded magnet, characterized in that the method comprises using and shaping a compound for rare earth metal-based bonded magnet according to the seventeenth feature into a predetermined shape in a process including at least a compression molding step, followed by heating and hardening the molding if necessary.

According to a twentieth aspect and feature of the present invention, in addition to the nineteenth feature, the compression molding is performed by pressing under a pressure of 0.1 GPa to 1 GPa.

According to the present invention, there are provided an oxidation-resistant rare earth metal-based magnet powder useful for producing rare earth metal-based bonded magnet which is not only excellent in oxidation resistance but also superior in magnetic characteristics and a method for producing the same, a compound for rare earth metal-based bonded magnet, a rare earth metal-based bonded magnet and a method for producing the same.

### BRIEF DESCRIPTION OF THE DRAWINGS

FIG. 1 is a graph for EXAMPLE I, showing the results of measuring a magnetic flux deterioration factor (an irreversible demagnetization factor) after the heating test comprising heating at 100° C. for 500 hours in air;

FIG. 2 is a graph similar to FIG. 1, except that the heating test comprises heating at 150° C. for 100 hours in air;

FIG. 3 is a graph for EXAMPLE I, showing the number of pores present on the surface;

FIG. 4 is a graph for EXAMPLE I, showing the relation between a time duration of immersion in water and a weight change ratio;

FIG. 5 is a graph for EXAMPLE II, showing the results of measuring a magnetic flux deterioration factor (an irreversible demagnetization factor) after the heating test comprising heating at 100° C. for 500 hours in air; and

FIG. 6 is a graph similar to FIG. 5, except that the heating test comprises heating at 150° C. for 100 hours in air.

### BEST MODE FOR CARRYING OUT THE INVENTION

The oxidation-resistant rare earth metal-based magnet powder according to the present invention can be produced by, for instance, mixing a rare earth metal-based magnet powder with a treating solution containing a pigment, and then drying the rare earth metal-based magnet powder having the treating solution containing the pigment adhered to the surface thereof.

As the method for preparing the treating solution containing the pigment, there can be mentioned, for example, a method comprising dispersing the pigment in weakly alkaline water whose pH is controlled to a range of 6.5 to 9.0 using ammonia and the like. The pH value of the treating solution is controlled to a range of 6.5 to 9.0 to avoid corrosion of the rare earth metal-based magnet powder due to the treating solution. The viscosity of the treating solution is preferably in a range of 2 cP to 50 cP from the viewpoint of assuring favorable handling properties. Additionally, the treating solution containing the pigment may be the one comprising the pigment dispersed in an organic solvent such as ethanol, isopropanol, and the like.

As the pigment, there may be used both types of pigments, i.e., organic pigments and inorganic pigments. As organic pigments, there can be mentioned, in addition to indanthrene based pigments and phthalocyanine based pigments, azo based, quinacridone based, anthraquinone based, dioxazine based, indigo based, thioindigo based, perinone based, perylene based, isoindoline based, azo methine azo based, and diketopyrrolopyrrole based, and the like. In case an organic pigment is used as the pigment, the rare earth metal-based magnet powder having on its surface the adhesion layer containing an organic pigment as a primary component imparts appropriate viscoelasticity and excellent fluidity to the compound for rare earth metal-based bonded magnet containing the resin binder, and, at the same time, the organic pigment constituting the adhesion layer absorbs and relaxes the stress that is applied to the compound during compression molding; hence, this is preferred from the viewpoint of preventing the generation of new broken surfaces due to the breaking down of magnet powder. Furthermore, some types of organic pigments are expected to impart high resistivity to the bonded magnets. In particular, since indanthrene based pigments and phthalocyanine based pigments have excellent corrosion resistance and heat resistance, these can be said as the preferred organic pigments.

As inorganic pigments, there can be mentioned carbon black, titanium dioxide, iron oxide, chromium oxide, zinc oxide, alumina, zinc sulfide, talc, mica, calcium carbonate, and the like. In case an inorganic pigment is used as the pigment, the rare earth metal-based magnet powder having on its surface the adhesion layer containing an inorganic pigment as a primary component is preferred for imparting particularly superior oxidation resistance to the magnet powder because the adhesion layer has excellent impermeability to oxygen and water vapor. Carbon black can be mentioned as the preferred inorganic pigment.

From the viewpoint of assuring uniform dispersibility of the pigment in the treating solution containing the pigment, the average particle diameter (major axis diameter) of the pigment is, preferably, in a range of 0.01 μm to 0.5 μm. If the average particle diameter sould be smaller than 0.01 μm, not only its production becomes difficult, but also it tends to agglomerate in the treating solution as to impair the handling properties. If the average particle diameter should exceed 0.5 μm, the specific gravity in the treating solution becomes too large as to cause sedimentation.

The content of the pigment in the treating solution is preferably in a range of 5 wt % to 33 wt %. If the content should be lower than 5 wt %, the adhesion layer containing sufficiently high amount of pigment cannot be formed on the surface of the rare earth metal-based magnet powder, thus, it is feared that this results in a failure of imparting excellent oxidation resistance to the magnet powder. If the content should exceed 33 wt %, the pigment may undergo agglomeration or sedimentation in the treating solution to thereby result in poor dispersibility. Thus, the content of the pigment in the treating solution is, more preferably, in a range of 10 wt % to 30 wt %.

It is preferred to add an organic dispersing medium in the treating solution containing the pigment. The organic dispersing medium is used with an objective of suppressing the agglomeration or sedimentation of the pigment in the treating solution. From the viewpoint of achieving the objective above, as well as from the viewpoint of affinity with the pigment and cost, the organic dispersing media favorably used are an anionic dispersing medium (for example, an aliphatic polycarboxylic acid, a salt of polyether polyester carboxylic acid, a salt of high molecular polyester acid polyamine, a salt of high molecular polycarboxylic acid long chain amine, and the like), a nonionic dispersing medium (for example, a carboxylic acid salt, a sulfonic acid salt, or an ammonium salt of polyoxyethylene alkyl ether or sorbitan ester, and the like), a high molecular dispersing medium (for example, a carboxylic acid salt, a sulfonic acid salt, or an ammonium salt of water-soluble epoxy; a styrene-acrylic acid copolymer, a glue, and the like).

The amount of addition of the organic dispersing medium into the treating solution is preferably in a range of 9 wt % to 24 wt %. If the amount of addition should be lower than 9 wt %, the dispersibility of the pigment may be lowered. On the other hand, if the amount of addition should exceed 24 wt %, the viscosity of the treating solution may become too high as to impair the handling properties.

The oxidation-resistant rare earth metal-based magnet powder may be produced by, for instance, immersing a rare earth metal-based magnet powder in a treating solution containing the pigment prepared in the aforementioned manner, mixing and stirring, and after filtering out the rare earth metal-based magnet powder having adhered to the surface thereof the treating solution containing the pigment, drying the resulting product. The total time for immersing the rare earth metal-based magnet powder in the treating solution containing the pigment, followed by mixing and stirring, is generally 1 to 20 minutes although it depends on the amount of the rare earth metal-based magnet powder. By using reduced pressure filtration or pressurized filtration in case of filtering out the rare earth metal-based magnet powder having adhered to the surface thereof the treating solution containing the pigment, the pigment can be more tightly adsorbed onto the surface of the magnet powder. In order to impart oxidation resistance to the rare earth metal-based magnet powder without causing deterioration of the magnetic characteristics, drying is preferably carried out by natural drying or in an inert gas (such as nitrogen gas, argon gas, and the like) atmosphere, or by heat drying at 80° C. to 120° C. in vacuum. In case of employing heat drying, the drying time is generally 20 minutes to 2 hours although it depends on the amount of the rare earth metal-based magnet powder. In case the thus filtered out rare earth metal-based magnet powder having adhered to the surface thereof the treating solution containing the pigment appears as an agglomerate, it is preferred to dry after disintegrating the agglomerate. Otherwise, the rare earth metal-based magnet powder having adhered to the surface thereof the treating solution containing the pigment may be obtained by spraying the treating solution containing the pigment to the rare earth metal-based magnet powder.

The adhesion layer containing a pigment as a primary component that is formed on the surface of the rare earth metal-based magnet powder obtained in such a manner described above imparts excellent oxidation resistance to the magnet powder, however, this adhesion layer is formed, not by a chemical reaction in which the magnet powder component is incorporated, but by the intermolecular force adsorption of fine pigment particles in the size of nanometers on the surface of the magnet powder. Accordingly, there are no problems during its formation as such that the vicinity of the surface of the magnet powder changes in quality as to deteriorate the magnetic characteristics. Thus, by using the oxidation-resistant rare earth metal-based magnet powder according to the present invention, there can be produced a rare earth metal-based bonded magnet which is not only excellent in oxidation resistance but also superior in magnetic characteristics.

Furthermore, the rare earth metal-based bonded magnets produced by using the oxidation-resistant rare earth metal-based magnet powder according to the present invention is superior in oxidation resistance in that not only the magnet powder has excellent oxidation resistance. In general, in shaping a bonded magnet, breaking of magnet powders occurs due to the molding pressure applied during the shaping of the bonded magnet because of insufficient fluidity of the magnet powder; accordingly, there are cases, for example, in which the magnet powder undergoes breakage as to generate the broken surfaces of the particles that are easily oxidized. However, in the case the oxidation-resistant rare earth metal-based magnet powder of the present invention is used, it is presumed that the pigment particles constituting the adhesion layer formed on the surface of the magnet powder exhibits a lubricating function to ameliorate the fluidity of the magnet powder during the shaping of the bonded magnet, and that the generation of broken surfaces of the particles due to the magnet powder broken by applied molding pressure, which are apt to be oxidized, is suppressed.

Furthermore, for shaping the rare earth metal-based bonded magnets, in case of employing a compression molding method or a molding method comprising a combination of compression molding and rolling (for instance, see “F. Yamashita, Applications of Rare-Earth Magnets to the Small motor industry, pp. 100-111, Proceedings of the seventeenth international workshop, Rare Earth Magnets and Their Applications, Aug. 18-22, 2002, Newark, Del., USA, Edited by G. C. Hadjipanayis and M. J. Bonder, Rinton Press”), and the like, in general, numerous pores generate on the surface of the produced bonded magnets. However, in the rare earth metal-based bonded magnets produced by using the oxidation-resistant rare earth metal-based magnet powder of the present invention, the pigment particles constituting the adhesion layer formed on the surface of the magnet powder exhibit a pore-sealing effect. It also is believed that the usage of the oxidation-resistant rare earth metal-based magnet powder of the present invention contributes to the realization of the rare earth metal-based bonded magnets with excellent oxidation resistance.

Since the present invention does not make the vicinity of the surface of the magnet powder change in quarity, even for a rare earth metal-based magnet powder having smaller average particle diameter (major axis diameter) (for instance, 200 μm or smaller), for instance, a magnetically anisotropic HDDR (Hydrogenation-Disproportionation-Desorption-Recombination) magnet powder (see JP-B-6-82575) having an average particle diameter of about 80 μm to 100 μm, which is produced by heating a rare earth metal-based magnet alloy in hydrogen for hydrogen absorption, followed by hydrogen desorption treatment, and cooling thereafter, an excellent oxidation resistance can be imparted thereto without causing deterioration of magnetic characteristics. Further, the rare earth metal-based magnet powder may be such subjected to a pretreatment by a method known in the art, such as pickling, degreasing, rinsing, and the like.

Furthermore, the oxidation-resistant rare earth metal-based magnet powder according to the present invention may be such having the adhesion layer containing a pigment as a primary component, which is adhered to the outermost surface, with one or more interposed layers of coating films formed on the surface of the rare earth metal-based magnet powder. Such an oxidation-resistant rare earth metal-based magnet powder can be produced, for instance, by mixing a rare earth metal-based magnet powder having one or more layers of coating films formed on the surface thereof with a treating solution containing a pigment, and then drying the rare earth metal-based magnet powder having adhered to the outermost surface thereof the treating solution containing the pigment. As rare earth metal-based magnet powders having one or more layers of coating films formed on the surface thereof, there can be mentioned, for instance, a rare earth metal-based magnet powder having a coating film made of an inorganic phosphoric acid compound as an oxidation resistant coating film formed on the surface thereof, as described in JP-A-64-11304 and JP-A-7-278602. However, the coating film that is formed on the surface of the rare earth metal-based magnet powders is not limited to that made of an inorganic phosphoric acid compound, but may be any oxidation resistant coating film well known in the art, for instance, a coating film made of a metal such as aluminum coating film and zinc coating film; or a resin coating film such as polyimide coating film; or a laminated film consisting of a plurality of coating films. Thus, even in case a coating film with an insufficient oxidation resistance is formed as a lower layer on the surface of the rare earth metal-based magnet powder, the adhesion layer containing the pigment as a primary component formed on the outermost surface of the rare earth metal-based magnet powder effectively compensates or reinforces the oxidation resistance.

A compound for rare earth metal-based bonded magnet can be produced by a method well known in the art from the oxidation-resistant rare earth metal-based magnet powder according to the present invention mixed with a resin binder. As resin binders, usable are thermosetting resins such as epoxy resin, phenolic resin, melamine resin, and the like; thermoplastic resins such as polyamides (nylon 66, nylon 6, nylon 12, and the like), polyethylene, polypropylene, polyvinyl chloride, polyester, polyphenylene sulfide, and the like; rubbers and estramers; modified products, copolymers, and mixtures thereof (for instance, those comprising a powder of a thermoplastic resin dispersed in a thermosetting resin (epoxy resin and the like): see “F. Yamashita, Applications of Rare-Earth Magnets to the Small motor industry, pp. 100-111, Proceedings of the seventeenth international workshop, Rare Earth Magnets and Their Applications, Aug. 18-22, 2002, Newark, Del., USA, Edited by G. C. Hadjipanayis and M. J. Bonder, Rinton Press”). The resin binder is preferably blended in the compound at an amount of 3 wt % or less with respect to the oxidation-resistant rare earth metal-based magnet powder. In obtaining a compound, an additive such as a coupling agent, a lubricant, a hardener, and the like may be added at an amount generally used in the art.

The rare earth metal-based bonded magnet using the oxidation-resistant rare earth metal-based magnet powder according to the present invention is produced by shaping the compound for rare earth metal-based bonded magnet prepared in the aforementioned manner into a predetermined shape by compression molding, injection molding, extrusion molding, and the like. For instance, in case of employing a compression molding method, those include, in addition to the compression molding method generally used in the art, a molding method comprising a combination of compression molding and rolling (for example, see above: “F. Yamashita, Applications of Rare-Earth Magnets to the Small motor industry, pp. 100-111, Proceedings of the seventeenth international workshop, Rare Earth Magnets and Their Applications, Aug. 18-22, 2002, Newark, Del., USA, Edited by G. C. Hadjipanayis and M. J. Bonder, Rinton Press”).

By compression molding the compound for rare earth metal-based bonded magnet, the pigment constituting the adhesion layer formed on the outermost surface of the magnet powder is pushed into the interstices between a particle and another particle of the magnet powder to fill the interstices. In this manner, the generation of pores on the surface and in the inside of the bonded magnet can be reduced. The compression molding of the compound is preferably carried out at a pressure in a range of 0.1 GPa to 1 GPa, and more preferably, in a range of 0.3 GPa to 0.6 GPa. If the pressure should be lower than 0.1 GPa, the pressure is too low for achieving sufficiently high densification of the bonded magnet, and this leads to a failure in effectively reducing the generation of pores. On the other hand, if the pressure should exceed 1 GPa, the pressure becomes too high, and there is fear of causing breakage of the magnet powder to generate new broken surfaces. The molding temperature is generally in a range of room temperature (20° C.) to 120° C., although it depends on the type of the resin binder. In order to obtain a high density bonded magnet by reducing the friction among the magnet powder particles or between the magnet powder particle and a resin binder, or, in order to facilitate filling of the interstices between a particle and another particle of the magnet powder with the pigment constituting the adhesion layer formed on the outermost surface of the magnet powder by increasing the fluidity to assure smooth movement of the pigment, the molding temperature is preferably set in a range of 80° C. to 100° C.

In case a thermosetting resin is used as the resin binder, the molding thus obtained is finally subjected to heating and hardening to obtain the rare earth metal-based bonded magnet. The heating and hardening of the molding is carried out in accordance with an ordinary method, for example, by heating under such conditions as at a temperature of 140° C. to 200° C. for 1 to 5 hours in an inert gas (such as nitrogen gas, argon gas, and the like) atmosphere or in vacuum.

Furthermore, with an objective of imparting further corrosion resistance and the like, various types of coating films, such as monolayers or laminates of resin paint coating films, electroplating coating films, and the like, may be formed on the rare earth metal-based bonded magnets produced according to the present invention.

### EXAMPLES

The present invention is explained in further detail below by means of examples, but it should be understood that the present invention is not limited thereto. In the following examples, HDDR magnet powder (average crystalline particle diameter : 0.4 μm) was used, which was prepared by radio-frequency melting and fabricating a cast ingot having a composition of: 12.8 at % Nd, 1.0 at % Dy, 6.3 at % B, 14.8 at % Co, 0.5 at % Ga, 0.09 at % Zr, and balance Fe, annealing the cast ingot in an argon gas atmosphere at 1100° C. for 24 hours, preparing a crushed powder with average particle diameter of 100 μm by crushing in an argon gas atmosphere with oxygen concentration of 0.5% or lower, subjecting the crushed powder to hydrogenation heat treatment under a pressurized hydrogen gas atmosphere of 0.15 MPa at 870° C. for 3 hours, and cooling after dehydrogenation treatment in an argon gas flow under reduced pressure (1 kPa) at 850° C. for 1 hour.

### Example I

### Example A

Experiment 1: Production of an Oxidation-Resistant HDDR Magnet Powder

An aqueous treating solution (viscosity: 10 cP) containing 17 wt % of carbon black (average particle diameter 0.08 μm), which is an inorganic pigment used as the pigment and 15 wt % of water-soluble epoxy carboxylate as the organic dispersing medium was prepared by mixing carbon black with water-soluble epoxy carboxylate in water and controlling the pH to 7.2 with ammonia.

In 50 mL of the treating solution was immersed 50 g of the HDDR magnet powder, and after mixing and stirring for 3 minutes at room temperature, the thus treated magnet powder was recovered by reduced pressure filtration for 30 seconds using an water-flow aspirator, and was then heated for drying in vacuum at 100° C. for 1 hour. The agglomerate thus obtained was disintegrated in a mortar to obtain a black-colored oxidation-resistant HDDR magnet powder, having adhered to the surface thereof an adhesion layer containing carbon black as a primary component.

To 1 g of the oxidation-resistant HDDR magnet powder thus prepared, a heating test comprising heating at 150° C. for 100 hours in the air was carried out to measure a weight gain ratio due to oxidation after testing with respect to the weight before testing. The result is given in Table 1.

Experiment 2: Manufacture of Bonded Magnet and its Characteristics

A 100:3 ratio by weight mixture of an epoxy resin and a phenolic hardener was dissolved in methyl ethyl ketone to prepare a resin solution. After uniformly mixing the oxidation-resistant HDDR magnet powder produced in Experiment 1 with the resin solution in such a manner that the resin solution should account for 3% by weight of the total weight of the oxidation-resistant HDDR magnet powder and the resin solution, methyl ethyl ketone was allowed to evaporate at the ordinary temperature to obtain a compound for rare earth metal-based bonded magnets in a powdery granular form. The compound for rare earth metal-based bonded magnets thus obtained was subjected to compression molding (hot molding under magnetic field at 100° C., Hex=0.96 MA/m, 0.6 GPa), and the molding thus obtained was heated for 1 hour at 150° C. in an argon gas atmosphere to harden the epoxy resin. Thus was obtained a bonded magnet having a size of 12.0 mm in length, 7.6 mm in width, and 7.4 mm in height, with a density of 5.9 g/cm³.

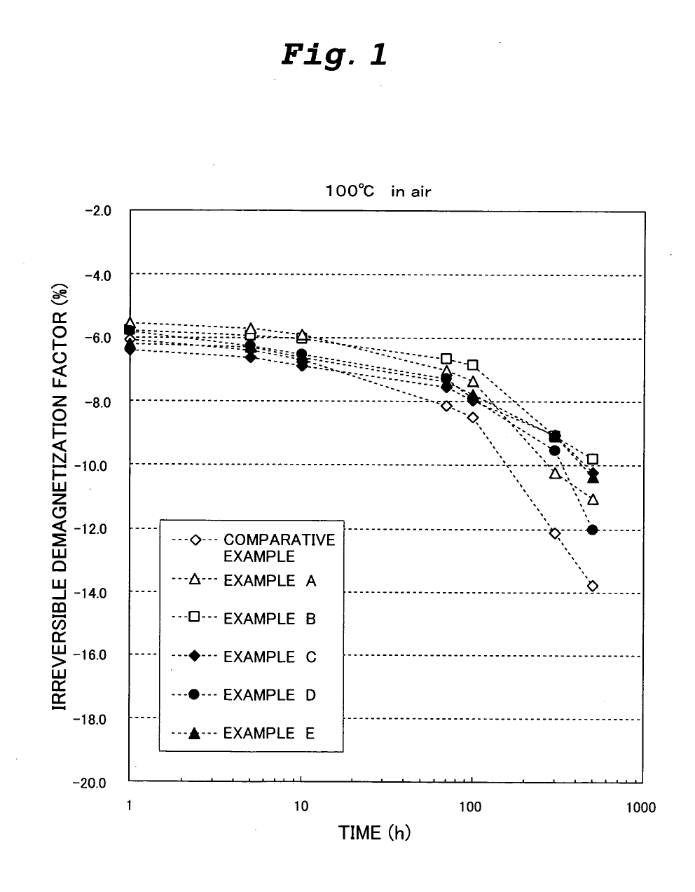

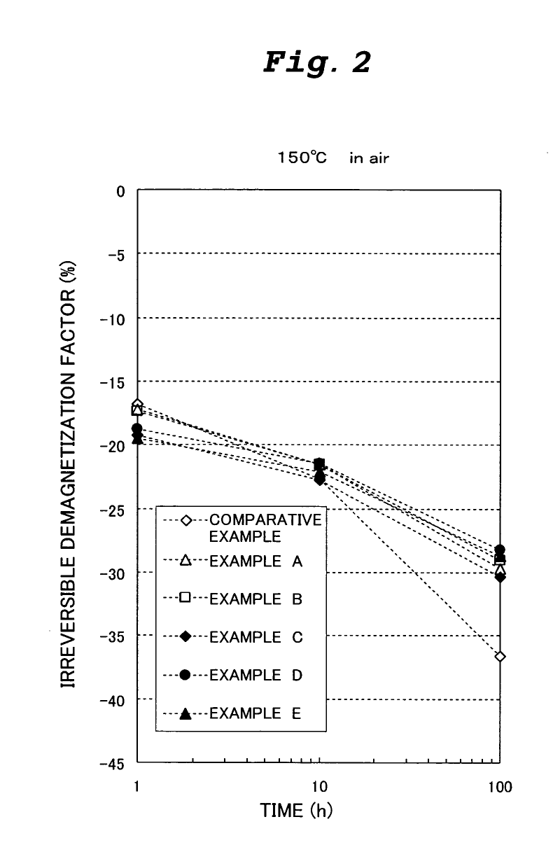

The bonded magnet thus manufactured was subjected to a heating test comprising heating at 150° C. for 100 hours in the air to measure a weight gain ratio due to oxidation after testing with respect to the weight before testing. Furthermore, after magnetizing the bonded magnet, heating tests each comprising heating at 100° C. for 500 hours in the air and at 150° C. for 100 hours in the air, respectively, were carried out to measure a magnetic flux deterioration factor (an irreversible demagnetization factor) after testing with respect to the magnetic flux before testing by each test. Then, the bonded magnet subjected to the heating test at 150° C for 100 hours in the air was subjected to re-magnetization to measure a magnetic flux deterioration factor (a permanent demagnetization factor) after re-magnetization with respect to the magnetic flux before testing. The results are given in FIGS. 1 and 2 and in Table 2.

### Example B

Experiment 1: Production of an Oxidation-Resistant HDDR Magnet Powder

An aqueous treating solution (viscosity: 15 cP) containing 17 wt % of indanthrene (average particle diameter 0.06 μm), which is an organic pigment used as the pigment and 15 wt % of water-soluble epoxy carboxylate as the organic dispersing medium was prepared by mixing indanthrene with water-soluble epoxy carboxylate in water and controlling the pH to 7.2 with ammonia.

Thus, similar to Experiment 1 in Example A, the treating solution above was used to produce an indigo-colored oxidation-resistant HDDR magnet powder, having adhered to the surface thereof an adhesion layer containing indanthrene as a primary component. Then, a heating test similar to that in Experiment 1 of Example A was performed on the thus produced oxidation-resistant HDDR magnet powder to measure a weight gain ratio due to oxidation after testing with respect to the weight before testing. The result is given in Table 1.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 1 and 2 and in Table 2.

### Example C

Experiment 1: Production of an Oxidation-Resistant HDDR Magnet Powder

An aqueous treating solution (viscosity: 17 cP) containing 17 wt % of copper phthalocyanine (average particle diameter 0.06 μm), which is an organic pigment used as the pigment and 15 wt % of water-soluble epoxy carboxylate as the organic dispersing medium was prepared by mixing copper phthalocyanine with water-soluble epoxy carboxylate in water and controlling the pH to 7.2 with ammonia.

Thus, similar to Experiment 1 in Example A, the treating solution above was used to produce an indigo-colored oxidation-resistant HDDR magnet powder, having adhered to the surface thereof an adhesion layer containing copper phthalocyanine as a primary component. Then, a heating test similar to that in Experiment 1 of Example A was performed on the thus produced oxidation-resistant HDDR magnet powder to measure a weight gain ratio due to oxidation after testing with respect to the weight before testing. The result is given in Table 1.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 1 and 2 and in Table 2.

### Example D

Experiment 1: Production of an Oxidation-Resistant HDDR Magnet Powder

An ethanol treating solution (viscosity: 30 cP) containing 17 wt % of indanthrene (average particle diameter 0.06 μm), which is an organic pigment used as the pigment and 15 wt % of acrylic polymer based high molecular dispersing medium as the organic dispersing medium was prepared by mixing indanthrene with acrylic polymer based high molecular dispersing medium in ethanol.

Thus, similar to Experiment 1 in Example A, the treating solution above was used to produce an indigo-colored oxidation-resistant HDDR magnet powder, having adhered to the surface thereof an adhesion layer containing indanthrene as a primary component. Then, a heating test similar to that in Experiment 1 of Example A was performed on the thus produced oxidation-resistant HDDR magnet powder to measure a weight gain ratio due to oxidation after testing with respect to the weight before testing. The result is given in Table 1.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 1 and 2 and in Table 2.

### Example E

Experiment 1: Production of an Oxidation-Resistant HDDR Magnet Powder

An ethanol treating solution (viscosity: 28 cP) containing 17 wt % of carbon black (average particle diameter 0.08 μm), which is an inorganic pigment used as the pigment and 15 wt % of acrylic polymer based high molecular dispersing medium as the organic dispersing medium was prepared by mixing carbon black with acrylic polymer based high molecular dispersing medium in ethanol.

Thus, similar to Experiment 1 in Example A, the treating solution above was used to produce a black-colored oxidation-resistant HDDR magnet powder, having adhered to the surface thereof an adhesion layer containing carbon black as a primary component. Then, a heating test similar to that in Experiment 1 of Example A was performed on the thus produced oxidation-resistant HDDR magnet powder to measure a weight gain ratio due to oxidation after testing with respect to the weight before testing. The result is given in Table 1.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 1 and 2 and in Table 2.

### Comparative Example

A heating test similar to that in Experiment 1 of Example A was performed on an HDDR magnet powder not subjected to any surface treatment, and a weight gain ratio due to oxidation after testing with respect to the weight before testing was measured. The result is given in Table 1. Furthermore, a bonded magnet was manufactured in the same manner as in Experiment 2 of Example A, except for using the HDDR magnet powder not subjected to any surface treatment. The same tests as in Experiment 2 of Example A were carried out on the thus manufactured bonded magnet. The results are given in FIGS. 1 and 2 and in Table 2.

TABLE 1

| Oxidation-resistant HDDR | |
|---|---|
| magnet powder | Weight gain ratio (%) |
| Example A | 0.05 |
| Example B | 0.05 |
| Example C | 0.06 |
| Example D | 0.04 |
| Example E | 0.04 |
| Comparative Example | 0.30 |
| (Non-treated powder) | |

TABLE 2

| | | 100° C. × 500 hrs | 150° C. × 100 hrs | Permanent demagnetization factor |
|---|---|---|---|---|
| | Weight | magnetic flux | magnetic flux | after re-magnetization (%) |
| Bonded | gain ratio | deterioration | deterioration | (Magnetic flux deterioration factor |
| magnet | (%) | factor (%) | factor (%) | due to oxidation) |
| Example A | 0.10 | −11.0 | −29.7 | −4.4 |
| Example B | 0.09 | −9.8 | −29.0 | −4.0 |
| Example C | 0.11 | −11.2 | −30.4 | −4.6 |
| Example D | 0.09 | −12.0 | −28.2 | −4.2 |
| Example E | 0.09 | −10.3 | −28.7 | −4.5 |
| Comparative | 0.32 | −13.8 | −36.6 | −7.9 |
| Example | | | | |

(n = 3)

From Table 1, it can be clearly understood that the oxidation-resistant HDDR magnet powders produced in Example A to Example E are each far lower in a weight gain ratio due to oxidation as compared with HDDR magnet powder not subjected to any surface treatment, and that thereby the magnet powders above are superior in oxidation resistance.

Furthermore, from FIGS. 1 and 2 and Table 2, it can be clearly seen that the bonded magnets of Example A to Example E yield smaller weight gain ratio and magnetic flux deterioration factor due to oxidation as compared with the bonded magnet of Comparative Example. Such superior characteristics of the bonded magnets of Example A to Example E can be explained by the fact that they are shaped into a predetermined shape using an HDDR magnet powder with excellent oxidation resistance imparted thereto, and that the generation of surface flaws due to cracks of the magnet powder and the like is suppressed any time during preparation of the compound, during compression molding for shaping the compound into a predetermined shape, or after shaping, thereby effectively preventing the oxidation from occurring. Furthermore, by observation of the surface of the bonded magnets above with a scanning electron microscope, there can be found that the pores thereof are sealed with the pigment particles bonded with the resin binder of the bonded magnet. This effect is believed to also contribute to the excellent oxidation resistance of the bonded magnet.

Evaluation A: The Number of Pores Present on the Surface of the Bonded Magnet

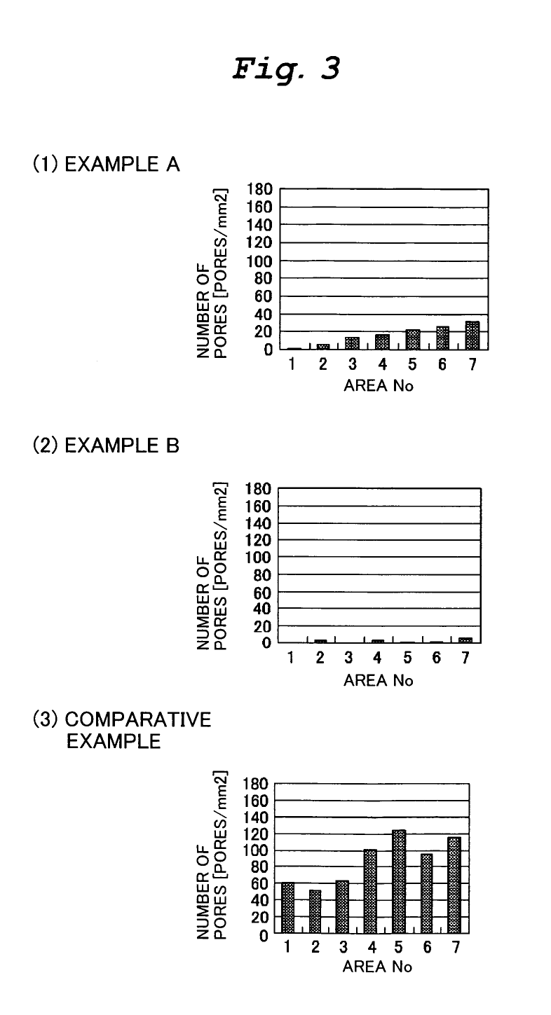

For each of the three types of bonded magnets, i.e., those in Example A, Example B, and Comparative Example, the plane 12.0 mm in length and 7.4 mm in height was divided into 7 equal areas along the direction of height, and the divided areas were numbered in the direction of compression, i.e., from the upper side to the lower side. The surface of each area was observed with an electron microscope. Pores 20 μm or larger in diameter were counted up in each of the areas, and the number of pores per 1 mm² was calculated. The results are given in FIG. 3. From FIG. 3, it can be clearly understood that the number of pores of the bonded magnets of Example A and Example B is far smaller than that of the bonded magnet of Comparative Example.

Evaluation B: The Relation Between a Time Duration of Immersion in Water and a Weight Change Ratio in the Bonded Magnet

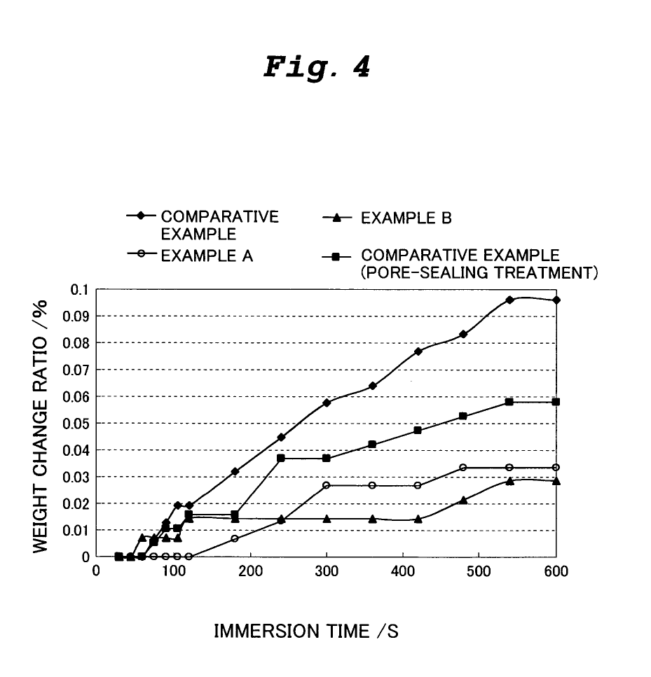

For each of the three types of bonded magnets, i.e., those in Example A, Example B, and Comparative Example, the relation between a time duration of immersion in water and a weight change ratio was investigated. The results are given in FIG. 4. As is clearly read from FIG. 4, the weight change ratio of the bonded magnets of Example A and Example B is far smaller than that of the bonded magnet of Comparative Example. Further, the weight change ratio of the bonded magnet obtained by subjecting the bonded magnet of Comparative Example to pore-sealing treatment falls between the weight change ratio of the bonded magnets of Example A and Example B and that of the bonded magnet of Comparative Example. These results show that the bonded magnet obtained by subjecting the bonded magnet of Comparative Example to pore-sealing treatment has the pores on the surface effectively treated, but that the pores in the inside of the magnet are insufficiently treated; on the other hand, it suggests that, for the bonded magnets of Example A and Example B, the generation of pores is reduced not only on the surface but also in the inside of the magnet.

Note: Method of Pore-Sealing Treatment for Bonded Magnet of Comparative Example

The bonded magnet of Comparative Example was immersed in the aqueous treating solution prepared in step 1 of Example A, and after applying infiltration of the treatment solution to pores under reduced pressure in a vacuum vessel whose pressure was held at 0.5 Pa, the bonded magnet was taken out from the vessel on recovering the ordinary pressure and the surface thereof was rinsed with water to remove the treating solution adhered in excess, followed by drying in air at 120° C. for 20 minutes.

### Example II

### Example A

Experiment 1: Production of an Oxidation-Resistant HDDR Magnet Powder

In 300 mL of an ethanol solution containing phosphoric acid at a concentration of 0.09 mol/L was immersed 100 g of the HDDR magnet powder, and after mixing and stirring for 3 minutes at room temperature, the thus treated magnet powder was recovered by reduced pressure filtration for 30 seconds using an water-flow aspirator, and was then heated for drying in vacuum at 120° C. for 30 minutes. Thus was formed a coating film made of an inorganic phosphoric acid compound on the surface of the HDDR magnet powder.

An aqueous treating solution (viscosity: 17 cP) containing 17 wt % of copper phthalocyanine (average particle diameter 0.06 μm), which is an organic pigment used as the pigment and 15 wt % of water-soluble epoxy carboxylate as the organic dispersing medium was prepared by mixing copper phthalocyanine with water-soluble epoxy carboxylate in water and controlling the pH to 7.2 with ammonia.

In 50 mL of the treating solution was immersed 50 g of the HDDR magnet powder having a coating film made of an inorganic phosphoric acid compound formed on the surface thereof, and after mixing and stirring for 3 minutes at room temperature, the thus treated magnet powder was recovered by reduced pressure filtration for 30 seconds using an water-flow aspirator, and was then heated for drying in vacuum at 100° C. for 1 hour. The agglomerate thus obtained was disintegrated in a mortar to obtain an indigo-colored oxidation-resistant HDDR magnet powder, having an adhesion layer containing copper phthalocyanine as a primary component, which was adhered to the outermost surface with the coating film made of an inorganic phosphoric acid compound interposed therebetween.

To 1 g of the oxidation-resistant HDDR magnet powder thus prepared, a heating test comprising heating at 150° C. for 100 hours in the air was carried out to measure a weight gain ratio due to oxidation after testing with respect to the weight before testing. The result is given in Table 3.

Experiment 2: Manufacture of Bonded Magnet and its Characteristics

A 100:3 ratio by weight mixture of an epoxy resin and a phenolic hardener was dissolved in methyl ethyl ketone to prepare a resin solution. After uniformly mixing the oxidation-resistant HDDR magnet powder produced in Experiment 1 with the resin solution in such a manner that the resin solution should account for 3% by weight of the total weight of the oxidation-resistant HDDR magnet powder and the resin solution, methyl ethyl ketone was allowed to evaporate at the ordinary temperature to obtain a compound for rare earth metal-based bonded magnets in a powdery granular form. The compound for rare earth metal-based bonded magnets thus obtained was subjected to compression molding (hot molding under magnetic field at 100° C., Hex=0.96 MA/m, 0.6 GPa), and the molding thus obtained was heated for 1 hour at 150° C. in an argon gas atmosphere to harden the epoxy resin. Thus was obtained a bonded magnet having a size of 12.0 mm in length, 7.6 mm in width, and 7.4 mm in height, with a density of 5.9 g/cm³.

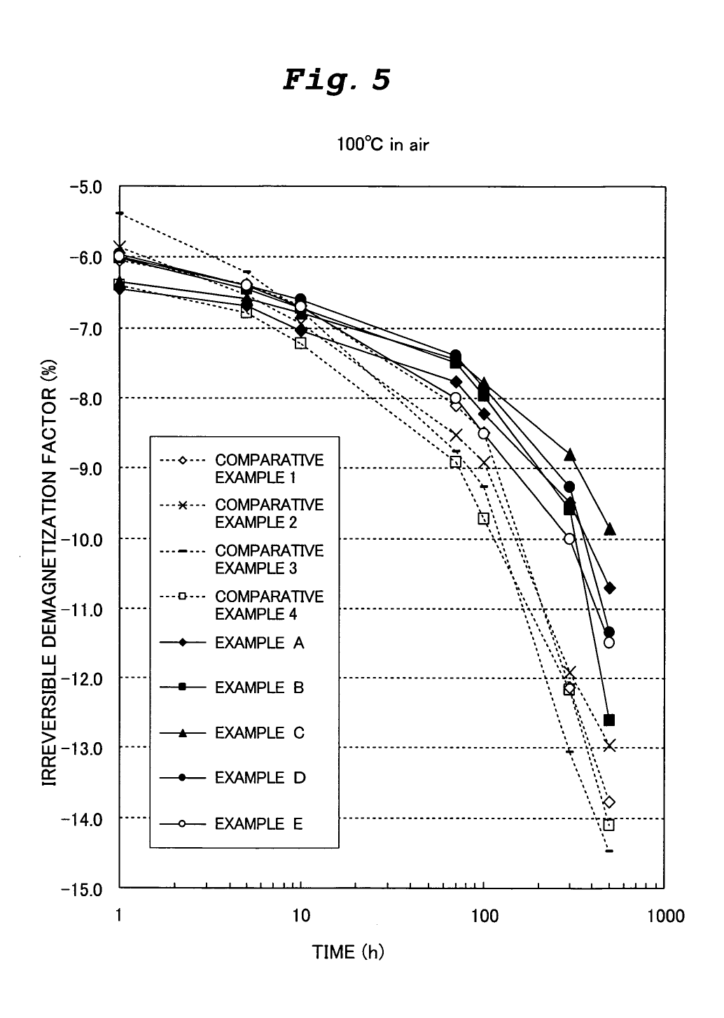

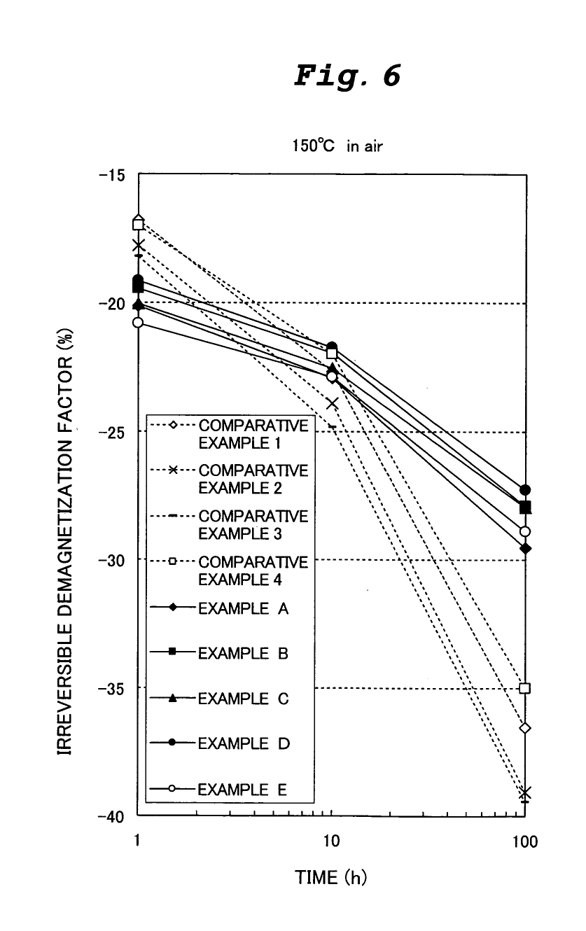

The bonded magnet thus manufactured was subjected to a heating test comprising heating at 150° C. for 100 hours in the air to measure a weight gain ratio due to oxidation after testing with respect to the weight before testing. Furthermore, after magnetizing the bonded magnet, heating tests each comprising heating at 100° C. for 500 hours in the air and at 150° C. for 100 hours in the air, respectively, were carried out to a measure magnetic flux deterioration factor (an irreversible demagnetization factor) after testing with respect to the magnetic flux before testing by each test. Then, the bonded magnet subjected to the heating test at 150° C. for 100 hours in the air was subjected to re-magnetization to measure a magnetic flux deterioration factor (a permanent demagnetization factor) after re-magnetization with respect to the magnetic flux before testing. The results are given in FIGS. 5 and 6 and in Table 4.

### Example B

Experiment 1: Production of an Oxidation-Resistant HDDR Magnet Powder

An ethanol treating solution (viscosity: 30 cP) containing 17 wt % of indanthrene (average particle diameter 0.06 μm), which is an organic pigment used as the pigment and 15 wt % of acrylic polymer based high molecular dispersing medium as the organic dispersing medium was prepared by mixing indanthrene with acrylic polymer based high molecular dispersing medium in ethanol.

Thus, similar to Experiment 1 in Example A, the treating solution above was used to produce an indigo-colored oxidation-resistant HDDR magnet powder, having an adhesion layer containing indanthrene as a primary component, which was adhered to the outermost surface with the coating film made of an inorganic phosphoric acid compound interposed therebetween. Then, a heating test similar to that in Experiment 1 of Example A was performed on the thus produced oxidation-resistant HDDR magnet powder to measure a weight gain ratio due to oxidation after testing with respect to the weight before testing. The result is given in Table 3.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 5 and 6 and in Table 4.

### Example C

Experiment 1: Production of an Oxidation-Resistant HDDR Magnet Powder

In 300 mL of an aqueous solution containing sodium dihydrogenphosphate at a concentration of 0.14 mol/L was immersed 100 g of the HDDR magnet powder, and after mixing and stirring for 3 minutes at room temperature, the thus treated magnet powder was recovered by reduced pressure filtration for 30 seconds using an water-flow aspirator, and was then heated for drying in vacuum at 120° C. for 30 minutes. Thus was formed a coating film made of an inorganic phosphoric acid compound on the surface of the HDDR magnet powder.

Thus, similar to Experiment 1 in Example A, the same treating solution as that used in Experiment 1 in Example A was used to produce an indigo-colored oxidation-resistant HDDR magnet powder, having an adhesion layer containing copper phthalocyanine as a primary component, which was adhered to the outermost surface with the coating film made of an inorganic phosphoric acid compound interposed therebetween. Then, a heating test similar to that in Experiment 1 of Example A was performed on the thus produced oxidation-resistant HDDR magnet powder to measure a weight gain ratio due to oxidation after testing with respect to the weight before testing. The result is given in Table 3.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 5 and 6 and in Table 4.

### Example D

Experiment 1: Production of an Oxidation-Resistant HDDR Magnet Powder

Similar to Experiment 1 in Example C, the same treating solution as that used in Experiment 1 in Example B was used to produce an indigo-colored oxidation-resistant HDDR magnet powder, having an adhesion layer containing indanthrene as a primary component, which was adhered to the outermost surface with the coating film made of an inorganic phosphoric acid compound interposed therebetween. Then, a heating test similar to that in Experiment 1 of Example A was performed on the thus produced oxidation-resistant HDDR magnet powder to measure a weight gain ratio due to oxidation after testing with respect to the weight before testing. The result is given in Table 3.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 5 and 6 and in Table 4.

### Example E

Experiment 1: Production of an Oxidation-Resistant HDDR Magnet Powder

A 0.3 μm thick Al coating film was formed on the surface of the HDDR magnet powder by a vacuum deposition method well known in the art.

Thus, similar to Experiment 1 in Example A, the same treating solution as that used in Experiment 1 in Example A was used to produce an indigo-colored oxidation-resistant HDDR magnet powder, having an adhesion layer containing copper phthalocyanine as a primary component, which was adhered to the outermost surface with the Al coating film interposed therebetween. Then, a heating test similar to that in Experiment 1 of Example A was performed on the thus produced oxidation-resistant HDDR magnet powder to measure a weight gain ratio due to oxidation after testing with respect to the weight before testing. The result is given in Table 3.

Experiment 2: Manufacture of Bonded Magnet and its Characteristics

A bonded magnet was manufactured in the same manner as in Experiment 2 of Example A, except for using the oxidation-resistant HDDR magnet powder obtained in Experiment 1 above. The same tests as in Experiment 2 of Example A were carried out on the thus manufactured bonded magnet. The results are given in FIGS. 5 and 6 and in Table 4.

### Comparative Example 1

A heating test similar to that in Experiment 1 of Example A was performed on an HDDR magnet powder not subjected to any surface treatment, and a weight gain ratio due to oxidation after testing with respect to the weight before testing was measured. The result is given in Table 3. Furthermore, a bonded magnet was manufactured in the same manner as in Experiment 2 of Example A, except for using the HDDR magnet powder not subjected to any surface treatment. The same tests as in Experiment 2 of Example A were carried out on the thus manufactured bonded magnet. The results are given in FIGS. 5 and 6 and in Table 4.

### Comparative Example 2

A heating test similar to that in Experiment 1 of Example A was performed on the HDDR magnet powder having a coating film made of an inorganic phosphoric acid compound formed on the surface thereof as was produced in Experiment 1 of Example A, and a weight gain ratio due to oxidation after testing with respect to the weight before testing was measured. The result is given in Table 3. Furthermore, a bonded magnet was manufactured in the same manner as in Experiment 2 of Example A, except for using this HDDR magnet powder. The same tests as in Experiment 2 of Example A were carried out on the thus manufactured bonded magnet. The results are given in FIGS. 5 and 6 and in Table 4.

### Comparative Example 3

A heating test similar to that in Experiment 1 of Example A was performed on an HDDR magnet powder having a coating film made of an inorganic phosphoric acid compound formed on the surface thereof as was produced in Experiment 1 of Example C, and a weight gain ratio due to oxidation after testing with respect to the weight before testing was measured. The result is given in Table 3. Furthermore, a bonded magnet was manufactured in the same manner as in Experiment 2 of Example A, except for using this HDDR magnet powder. The same tests as in Experiment 2 of Example A were carried out on the thus manufactured bonded magnet. The results are given in FIGS. 5 and 6 and in Table 4.

### Comparative Example 4

A heating test similar to that in Experiment 1 of Example A was performed on an HDDR magnet powder having an Al coating film formed on the surface thereof as was produced in Experiment 1 of Example E, and a weight gain ratio due to oxidation after testing with respect to the weight before testing was measured. The result is given in Table 3. Furthermore, a bonded magnet was manufactured in the same manner as in Experiment 2 of Example A, except for using this HDDR magnet powder. The same tests as in Experiment 2 of Example A were carried out on the thus manufactured bonded magnet. The results are given in FIGS. 5 and 6 and in Table 4.

TABLE 3

| Oxidation-resistant | |
|---|---|
| HDDR magnet powder | Weight gain ratio (%) |
| Comparative Example 1 | 0.30 |
| (Non-treated powder) | |
| Comparative Example 2 | 0.01 |
| Comparative Example 3 | 0.01 |
| Comparative Example 4 | 0.01 |
| Example A | 0.01 |
| Example B | 0.01 |
| Example C | 0.01 |
| Example D | 0.01 |
| Example E | 0.01 |

TABLE 4

| | | 100° C. × 500 hrs | 150° C. × 100 hrs | Permanent demagnetization |
|---|---|---|---|---|
| | Weight | Magnetic flux | Magnetic flux | factor after re-magnetization (%) |
| Bonded | gain ratio | deterioration | deterioration | (Magnetic flux deterioration factor |
| magnet | (%) | factor (%) | factor (%) | due to oxidation) |
| Comparative | 0.32 | −13.8 | −36.6 | −7.9 |
| Example 1 | | | | |
| Comparative | 0.34 | −13.0 | −39.1 | −9.0 |
| Example 2 | | | | |
| Comparative | 0.34 | −14.5 | −39.4 | −9.9 |
| Example 3 | | | | |
| Comparative | 0.33 | −14.1 | −35.0 | −7.7 |
| Example 4 | | | | |
| Example A | 0.08 | −10.7 | −29.5 | −4.3 |
| Example B | 0.06 | −12.6 | −27.9 | −3.8 |
| Example C | 0.06 | −9.9 | −27.9 | −3.7 |
| Example D | 0.05 | −11.3 | −27.3 | −3.8 |
| Example E | 0.07 | −11.5 | −28.9 | −4.0 |

(n = 3)

From Table 3, it can be clearly understood that the oxidation-resistant HDDR magnet powders produced in Example A to Example E, as well as the surface-coated HDDR magnet powders produced in Comparative Example 2 to Comparative Example 4, are each far lower in a weight gain ratio due to oxidation as compared with HDDR magnet powder not subjected to any surface treatment of Comparative Example 1, and that thereby the magnet powders above are superior in oxidation resistance.

However, from FIGS. 5 and 6 and Table 4, it can be clearly understood that the bonded magnets of Comparative Example 2 to Comparative Example 4 exhibit distinct weight gain ratio and magnetic flux deterioration factor due to oxidation well comparable to the bonded magnet of Comparative Example 1. On the other hand, the bonded magnets of Example A to Example E yield smaller weight gain ratio and magnetic flux deterioration factor due to oxidation as compared with the bonded magnet of Comparative Example 1. Such superior characteristics of the bonded magnets of Example A to Example E can be explained by the fact that they are shaped into a predetermined shape using an HDDR magnet powder with excellent oxidation resistance imparted thereto, and that, differing from the bonded magnets of Comparative Example 2 to Comparative Example 4, the generation of surface flaws due to cracks of the magnet powder and the like is suppressed any time during preparation of the compound, during compression molding for shaping the compound into a predetermined shape, or after shaping, thereby effectively preventing the oxidation from occurring. Furthermore, by observation of the surface of the bonded magnets of Example A to Example E with a scanning electron microscope, there can be found that the pores thereof are sealed with the pigment particles bonded with the resin binder of the bonded magnet. This effect is believed to also contribute to the excellent oxidation resistant of the bonded magnet.

### INDUSTRIAL APPLICABILITY

The present invention possesses industrial applicability in the point that it provides an oxidation-resistant rare earth metal-based magnet powder useful for producing rare earth metal-based bonded magnet which is not only excellent in oxidation resistance but also superior in magnetic characteristics and a method for producing the same, a compound for rare earth metal-based bonded magnet, a rare earth metal-based bonded magnet and a method for producing the same.

1. An oxidation-resistant rare earth metal-based magnet powder, characterized in that it has on its surface an adhesion layer containing a pigment as a primary component.

2. The oxidation-resistant rare earth metal-based magnet powder as claimed in claim 1, characterized in that said pigment is an inorganic pigment.

3. The oxidation-resistant rare earth metal-based magnet powder as claimed in claim 2, characterized in that said inorganic pigment is carbon black.

4. The oxidation-resistant rare earth metal-based magnet powder as claimed in claim 1, characterized in that said pigment is an organic pigment.

5. The oxidation-resistant rare earth metal-based magnet powder as claimed in claim 4, characterized in that said organic pigment is an indanthrene based pigment or a phthalocyanine based pigment.

6. The oxidation-resistant rare earth metal-based magnet powder as claimed in claim 1, characterized in that the average particle diameter (major axis diameter) of said pigment is in a range of 0.01 μm to 0.5 μm.

7. The oxidation-resistant rare earth metal-based magnet powder as claimed in claim 1, characterized in that the average particle diameter (major axis diameter) of said rare earth metal-based magnet powder is not larger than 200 μm.

8. The oxidation-resistant rare earth metal-based magnet powder as claimed in claim 7, characterized in that said rare earth metal-based magnet powder is an HDDR magnet powder.

9. The oxidation-resistant rare earth metal-based magnet powder as claimed in claim 1, characterized in that it has said adhesion layer adhered to the outermost surface, with one or more interposed layers of coating films formed on the surface of said rare earth metal-based magnet powder.

10. The oxidation-resistant rare earth metal-based magnet powder as claimed in claim 9, characterized in that said coating film formed on the surface of said rare earth metal-based magnet powder is a coating film made of an inorganic phosphoric acid compound.

11. The oxidation-resistant rare earth metal-based magnet powder as claimed in claim 9, characterized in that said coating film formed on the surface of said rare earth metal-based magnet powder is a coating film made of a metal.

12. A method for producing an oxidation-resistant rare earth metal-based magnet powder having on its surface an adhesion layer containing a pigment as a primary component, characterized in that the method comprises mixing a rare earth metal-based magnet powder with a treating solution containing the pigment, and then drying the rare earth metal-based magnet powder having adhered to the surface thereof the treating solution containing the pigment.

13. The production method as claimed in claim 12, characterized in that the method comprises mixing a rare earth metal-based magnet powder with a treating solution containing the pigment, and then obtaining by filtration the rare earth metal-based magnet powder having adhered to the surface thereof the treating solution containing the pigment.

14. The production method as claimed in claim 12, characterized in that the pigment accounts for 5 wt % to 33 wt % of said treating solution containing the pigment.

15. The production method as claimed in claim 12, characterized in that said treating solution containing the pigment comprises an organic dispersing medium.

16. A method for producing an oxidation-resistant rare earth metal-based magnet powder having an adhesion layer containing a pigment as a primary component adhered to the outermost surface with one or more interposed layers of coating films formed on the surface of the rare earth metal-based magnet powder, characterized in that the method comprises mixing a rare earth metal-based magnet powder having one or more layers of coating films formed on the surface thereof with a treating solution containing the pigment, and then drying the rare earth metal-based magnet powder having adhered to the outermost surface thereof the treating solution containing the pigment.

17. A compound for rare earth metal-based bonded magnet, characterized in that it comprises an oxidation-resistant rare earth metal-based magnet powder as claimed in claim 1 and a resin binder.

18. A rare earth metal-based bonded magnet, characterized in that a compound for rare earth metal-based bonded magnet as claimed in claim 17 is used and shaped into a predetermined shape.

19. A method for producing a rare earth metal-based bonded magnet, characterized in that the method comprises using and shaping a compound for rare earth metal-based bonded magnet as claimed in claim 17 into a predetermined shape in a process including at least a compression molding step, followed by heating and hardening the molding if necessary.

20. The production method as claimed in claim 19, characterized in that said compression molding is performed by pressing under a pressure of 0.1 GPa to 1 GPa.
